(19) United States
(12) Patent Application Publication
(10) Pub. No.: US 2001/0045326 A1
(43) Pub. Date: Nov. 29, 2001

(54) Elevator system for the vertical transport of payloads in an aircraft

(76) Inventors: Stephan Gottlieb, Herdecke (DE); Joachim Schmidt, Tomesch (DE); Adolf Schreger, Pinneberg (DE)

Correspondence Address: Gerald H. Kiel Esq., REED SMITH, LLP, 375 Park Avenue, New York, NY, 10152-1799, US

(21) Appl. No.: 09/860,347

(22) Filed: May 17, 2001

(30) Foreign Application Priority Data
May 19, 2000 (DE) 100 24 973.6

(51) Int. Cl. B66B 1/00; B66B 11/08; B66B 1/28; B66B 7/04

(52) U.S. Cl. 187/254; 187/277; 187/296; 187/297; 187/410

(57) ABSTRACT

An elevator system for the vertical transport of payloads in an aircraft is disclosed. The arrangement of the elevator system provides for the vertical transport of payloads in an aircraft which permits low-noise, reliably operating conveying between different levels of the aircraft and reliable stopping in the loading and unloading positions. The arrangement is characterized by low maintenance and low weight, in that the drive system has at least one closed belt for driving and for receiving the load of the elevator cabin, which belt is guided at either end of the mast on deflection rolls and has, between the deflection rolls, at least one freely accessible belt portion oriented parallel to the mast for fastening the elevator cabin and for the movement of the elevator cabin along the mast. The deflection rolls and the belt are provided with teeth which are adapted to one another and the belt is pretensioned in a defined manner. One of the deflection rolls communicates with a drive motor which has a large torque and can be well regulated, wherein the drive motor, apart from its driving function, is also provided for braking and holding the elevator cabin load.

### BACKGROUND OF THE INVENTION

a) Field of the Invention

The invention is directed to an elevator system for the vertical transport of useful loads or payloads in an aircraft, particularly for the transport of trolleys between the different decks of an airplane.

b) Description of the Related Art

Elevator systems in aircraft are subject to special requirements with respect to stability, reliability of operation and load fixing because of special dynamic stresses during flight (different force effects at take-off and landing or during turbulence). For this reason, certain known elevator principles, e.g., Koepe sheave or driving disk with cable pull and load counterweights, and cable drum wind-up are not even taken into consideration.

As regards gravitational force and acceleration forces, independent drives are known in different constructions. Among these latter are, for example, hydraulic drives in which the elevator cabin is moved vertically above a hydraulic cylinder comprising multiple members. The heavy weight and considerable space requirement below the elevator cabin are disadvantageous and unacceptable for aircraft.

Further, rack-and-pinion drives have been used as elevator drives. In this type of drive, it is disadvantageous that the drive motor travels along with the cabin as an additional load and that an upward movement and downward movement which is free from play requires extensive adjustment and maintenance.

Spindle drives have been most successful in aircraft because the elevator drive which is free from play can be constructed in a substantially improved manner. In this drive, a vertically arranged spindle is driven in a column, this spindle providing for the upward movement and downward movement and vertical fixing of the cabin by means of a spindle nut communicating with the elevator cabin. The column itself has suitable open strand sections at which the cabin is guided. However, there remain the disadvantages of high maintenance by lubrication, a relatively substantial noise level and relatively heavy weight of the load-carrying spindle and its bearing.

### OBJECT AND SUMMARY OF THE INVENTION

It is the primary object of the invention to find a novel possibility for the arrangement of an elevator system for the vertical transport of payloads in an aircraft which permits low-noise, reliably operating conveying between different levels of the aircraft and reliable stopping in the loading and unloading positions and which is characterized by low maintenance and low weight.

In an elevator system for the vertical transport of payloads in an aircraft with an elevator cabin and a mast for load carrying and for guiding the elevator cabin between different horizontal levels, wherein the elevator cabin is moved and stopped in a defined manner by a drive system arranged at the mast, the object mentioned above is met, according to the invention, in that the drive system has at least one closed belt for driving and for load suspension of the elevator cabin, which belt is guided at the lower end and upper end of the mast on deflection rolls and has, between the deflection rolls, at least one freely accessible belt portion oriented parallel to the mast for fastening the elevator cabin and for the movement of the elevator cabin along the mast, in that the deflection rolls and the belt are provided with teeth which are adapted to one another and the belt is pretensioned in a defined manner, and in that one of the deflection rolls communicates with a drive motor which has a large torque and can be well regulated, wherein the drive motor, apart from its driving function, is also provided for braking and holding the elevator cabin load.

The toothing of the deflection rolls and the belt advantageously has an additional lateral guide in order to prevent the belt from wandering out of the running surface of the deflection rolls. The deflection rolls and belt preferably have a spiral toothing.

The belt is advisably formed of a base material of ductile plastic and longitudinally oriented strand inlays, wherein the base material of the belt preferably comprises polyurethane in which steel wires or carbon fibers (carbon strands) are inserted.

The toothing of the belt advantageously has a more wear-resistant layer, preferably polyamide, over the base material at the tooth flanks in order to reduce belt wear.

In order to increase reliability and security, it has proven advantageous when a plurality of belts are provided as load carrying means for the elevator cabin, wherein the deflection rolls of the belts which are guided next to one another are arranged on a common shaft at the upper end and lower end of the mast.

The deflection rolls are advisably mounted at the upper end of the mast on a shaft with a weight measuring device for monitoring belt tension and load limits of the elevator system, wherein an overload triggers the locking of the drive shaft and the switching off of the drive motor during load transport and the belt pretensioning can be checked and adjusted during idling.

For extensive prevention of vertical vibrations of the elevator cabin, it is advantageous to provide a tensioning device for the belts which is arranged in an area of the freely accessible belt portion that is concealed by the elevator cabin, so that the belt can be readjusted by applying defined pretensioning.

To simplify the control of the elevator cabin and motor, the drive motor advisably has a measuring device for detecting rotor positions, wherein the position of the elevator cabin can be correlated to the rotor position of the drive motor by means of this measuring device via the toothing of the belts. The position of the elevator cabin relative to the floor of a respective deck of the aircraft is accordingly adjustable in a continuous and simple manner preferably by programming a controlling and regulating circuit which is arranged downstream of the measuring device for rotor position detection. For this purpose, the drive motor is advantageously guided at an AC converter which, based on the measurements of the rotor position, regulates the current of the drive motor, determines the exact position of the elevator cabin and moves toward a predetermined position in a deliberate manner.

Because of the requirements for high torque and very good controllability, a brushless DC servo motor which is temperature-monitored in addition for detecting interference and overload is advantageously used as drive motor.

A step-down gear unit is advantageously provided for generating or holding a high torque of the drive shaft required for driving and braking.

A mechanical brake device is advisably provided at the drive shaft to stop the elevator cabin in the currentless state of the drive motor in case of overload or breakdown.

The mast which has the function of supporting and guiding the entire elevator cabin is advantageously formed of hollow sections whose quantity and size are adapted to the quantity and dimensions of the belts. The hollow sections are constructed as channels for the return of the belts. The mast preferably has end modules at the end of the hollow sections for receiving the deflection rolls.

The mast is outfitted with a lower and an upper mast fastening in such a way that all of the weight is deliberately received in the supporting structure of the aircraft via the lower mast fastening, the upper mast fastening being provided only for receiving all horizontal forces in a supporting structure of the aircraft which is situated higher. The lower mast fastening is advantageously constructed in a lower deck of the aircraft as a pendulum bearing, wherein a movability of the mast is ensured in the longitudinal axis and transverse axis of the aircraft about this pendulum bearing. On the other hand, the mast is fastened to a higher deck of the aircraft via a sliding pendulum bearing which fixes the mast in the longitudinal axis and transverse axis of the aircraft but does not offer resistance in opposition to the movements of the deck relative to one another. For this mast construction, it is advantageous that stiffening or reinforcement is provided only in the region of the lower pendulum bearing in the supporting structure of the aircraft for load suspension of the entire elevator system.

Further, at the sides, i.e., in transverse direction to the side on which the elevator cabin is arranged, the mast advantageously has a section rail or two U-sections located across from one another as guide rails for the movement of the elevator cabin.

For supporting the payload and inherent load or empty load of the elevator cabin in the orthogonal plane relative to the longitudinal direction of the mast, a plurality of groups of guide rollers are advantageously provided at the guide rails for guiding the elevator cabin along each side of the mast, wherein the guide rollers roll on different surfaces of the respective guide rail of the mast closely adjacent to one another. The guide rollers of a group are advisably arranged so as to be offset relative to one another in direction of the guide rail. The guide rollers are preferably grouped in pairs, at least two pairs rolling on each guide rail.

The different rolling surfaces of the guide rails on which a pair of rollers rolls are advantageously the (almost concealed) inner sides of the U-section sides or legs in a guide rail with U-section. In case of an individual rail, the guide rollers would roll in a functionally identical manner on opposite surfaces of one and the same shaped part of the rail.

In order for the elevator cabins to be guided exactly in each horizontal direction relative to the mast, the guide rollers are preferably constructed as two-roller systems, wherein the latter have a non-rotating central part about which the main guide roller revolves and at which a smaller transverse guide roller is embedded on the front side with respect to the main guide roller in such a way that the two-roller system rolls in a defined manner at a side surface as well as at the base (U-section base or rail flange) of the guide rail.

A slide or carriage is advantageously provided between the mast and elevator cabin for coupling the elevator cabin to the freely accessible belt portion and for linear guidance along the mast, wherein the guide rollers for guiding the elevator cabin which engage laterally in the mast are fastened to the carriage and there is a mounting surface for the rigid fastening of the elevator cabin.

The carriage advisably has the shape of a wide U-section, wherein the mast essentially penetrates inside this U-shaped carriage and the shafts of the guide rollers are oriented parallel to the mounting surface of the carriage at the inner sides of the legs of the carriage, and sections of the guide rails of the mast engage in the oppositely located sections.

The elevator cabin is preferably fastened to the carriage by means of a quick-closure to facilitate maintenance and exchange. For this purpose, at least one peg is advisably provided at the carriage for load suspension of the elevator cabin, which peg either has a quarter-turn fastener or an eccentric lever for securing the elevator cabin to the peg without slippage.

The fundamental idea of the invention is based on the thought that the particular conditions for elevator systems in air travel and space travel, namely, guaranteeing unconditional protection against negative accelerations and uncontrolled movements of the elevator cabin in all conceivable movement sequences of the aerodynamic vehicle while simultaneously limiting volume and weight and reducing maintenance and noise, can only be met by departing from gearing types comprising toothed metal linear drives. The solution consists in that the cabin movement is carried out by means of a conveying belt drive which satisfies the necessary conditions in cooperation with an anti-slip device (toothed belt) and determined measuring and regulating devices (weight measuring device and measuring device for detecting the rotor position). In addition, a suitable column construction (mast supported on pendulum bearings) is provided for vertical load suspension, which column construction, in particular, meets the requirements of compatibility with respect to twisting or torsion and other positional deviations (caused, e.g., by temperature variations) of the supporting structure of an aerodynamic vehicle and, besides the supporting function, also takes over the linear guidance of the cabin carriage and the lateral support of the elevator system. Due to the fact that this type of drive is not dependent on gravitational force and due to the load-independent carriage guide and the sliding guidance of the mast (sliding/pendulum bearing), application of the invention is not limited to aircraft and should be expressly understood as extending also to space vehicles.

In an elevator system for aircraft which is realized in the manner mentioned above, a low-noise, reliably operating transport of payloads between different levels (decks) of an aerodynamic vehicle and dependable stopping in the charging and unloading positions are achieved with reduced weight and reduced maintenance.

The invention will be described more fully in the following with reference to an embodiment example.

### BRIEF DESCRIPTION OF THE DRAWINGS

In the drawings:

FIG. 1 shows a full view of the elevator system according to the invention;

FIG. 2 shows a particularly advantageous embodiment form of the drive belts;

FIG. 3 shows a preferred design of the mast section;

FIG. 4 shows an advantageous construction of the pendulum sliding bearing of the upper mast fastening;

FIG. 5 shows an advisable arrangement of the carriage guide at the mast; and

FIG. 6 shows a preferred embodiment form of the guide rollers of the carriage with integrated transverse guide roller at the U-section base of the mast.

### DESCRIPTION OF THE PREFERRED EMBODIMENTS

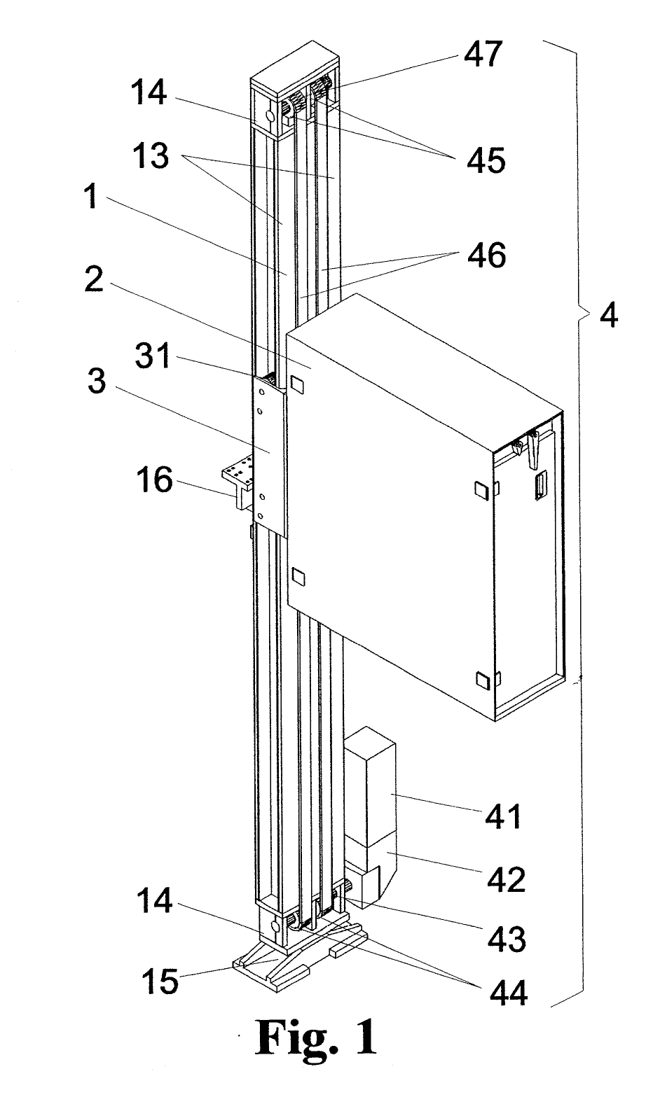

In its basic construction, the elevator system according to the invention comprises—as is shown in FIG. 1—a mast 1 which, besides the supporting function, also combines the functions of vertical driving and lateral guiding, an elevator cabin 2 for receiving material to be transported which is connected with the mast 1 so as to be vertically movable via a carriage 3, and a drive system 4 comprising a drive motor 41, at least one drive belt 46 for converting the rotational movement of the drive motor 41 into a linear movement of the elevator cabin 2, wherein every drive belt 46 is guided over a lower deflection roll 44 at the lower end of the mast 1 and an upper deflection roll 45 at the upper end of the mast.

Although the elevator system according to the invention is always described in the following in relation to aircraft, especially airplanes, and the transported material is referred to as payload, the elevator system is also suitable for applications in space travel because of its special gravity-independent drive system and its carriage guidance which is free from play and not dependent on load, and is expressly not limited to aircraft.

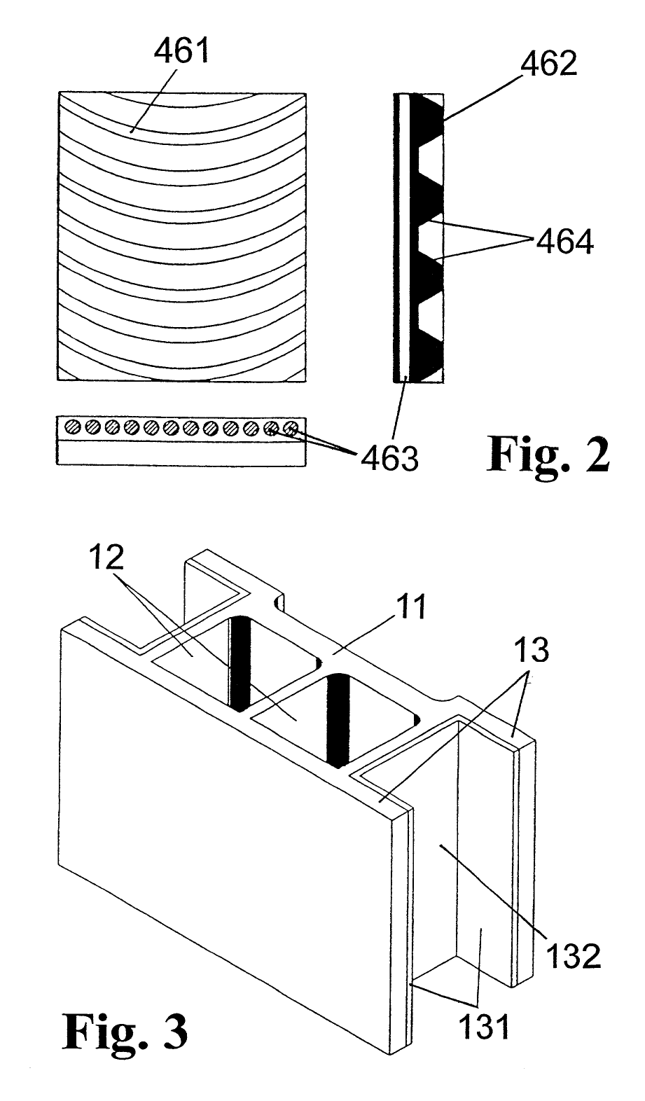

FIG. 1 shows an elevator system which is designed specifically for an airplane and which has two drive belts 46. The belts 46 are guided at the upper end of the mast 1 by the upper deflection rolls 45 which revolve in an end module 14 of the mast 1 on a common shaft. At the bottom end of the mast, the lower deflection rolls 44 are likewise guided in an end module 14 on a common shaft which simultaneously forms the drive shaft 43 of the drive system 4. The drive shaft 43 is driven by the drive motor 41 via a step-down gear unit 42 at the required torque for moving, braking and holding the payload and inherent load of the elevator cabin 2. The drive motor 41 is advisably a brushless DC servo motor guided at an AC converter which, on the basis of measurements of a measuring device for detecting the rotor position, regulates the current of the drive motor 41, determines the exact position of the elevator cabin 2 and moves specifically to a predetermined elevator position. In order to ensure vibrationless movement of the elevator cabin 2 and transmission of force from the drive motor 41 to the elevator cabin 2 which is always secure and free from slippage, a carriage 3 is provided at the mast 1 for reliable guidance of the cabin. The drive belts 46 are pretensioned at this carriage 3 by means of a tensioning device (not shown). In addition, the drive belts 46 are provided with teeth and the deflection rolls 44 and 45 have a corresponding toothing. This toothing is advisably constructed in such a way that there is simultaneously a lateral guiding of the belts 46 on the deflection rolls 44 and 45. For this purpose, a possible arrangement of the tooth pattern as a spiral toothing 461 is shown in a top view on the left-hand side of FIG. 2. The lower view of FIG. 2 shows the cross section of a drive belt 46 which has highly elongation-resistant strand inlays 463 in the base material 462 in the form of steel wires or carbon fibers in the longitudinal direction of the belt 46. In addition, the view at right shows a longitudinal section of the drive belt 46 to illustrate that the base material 462, which is preferably made of polyurethane (or a similarly ductile plastic) and in which the strand inlays 463 are embedded, is provided at the tooth flanks with a more wear-resistant layer 464 made, for example, from polyamide.

The carriage 3 is fastened to the freely accessible portions of the drive belts 46 at the mast 1 (externally) and is supported by these freely accessible portions, so that the belts 46 receive the entire inherent load and payload of the elevator cabin 2 and transmit them to the mast 1 via the upper deflection rolls 45. In this connection, the full load is supported on the upper end module 14 of the mast 1, the upper deflection rolls 45 and a weight measuring device 47 being located in this upper end module 14 on a common shaft, and is transmitted to the drive shaft 43 via the (returning) portion of the drive belts 46 running back to the lower deflection rolls 44. The weight measuring device 47 is used primarily for adjusting and monitoring a defined pretensioning of the belts 46, but also serves as a safety device in cases of overload and breakdown (e.g., overloading or blocking of the elevator cabin, etc.).

FIG. 3 shows the mast 1 in cross section, wherein the supporting function is realized by a torsion-resistant hollow section 11. The hollow section 11 has a quantity of vertical, preferably rectangular, channels 12 corresponding to the number of drive belts 46 for the elevator system. In this example, there are two channels 12, each channel 12 receiving the return of the drive belts 46 between the upper and lower deflection rolls 45 and 44. There are guide rails 13 at the lateral flanks of the mast 1 for receiving the guide rollers 31 of the carriage 3 in the form of U-sections, wherein the channels 12 of the hollow section 11 of the mast 1 are located between the oppositely oriented guide rails 13.

With respect to function, the mast 1 is conceived in such a way that the entire inherent load and payload of the elevator system is absorbed by the lower end of the mast in a pendulum bearing 15 and the lateral (horizontal) forces are intercepted by an upper mast fastening in the form of a pendulum sliding bearing 16. The lower pendulum bearing 15 can be constructed in the manner of a spherical head bearing which is integrated in a base element that is shown schematically in FIG. 1.

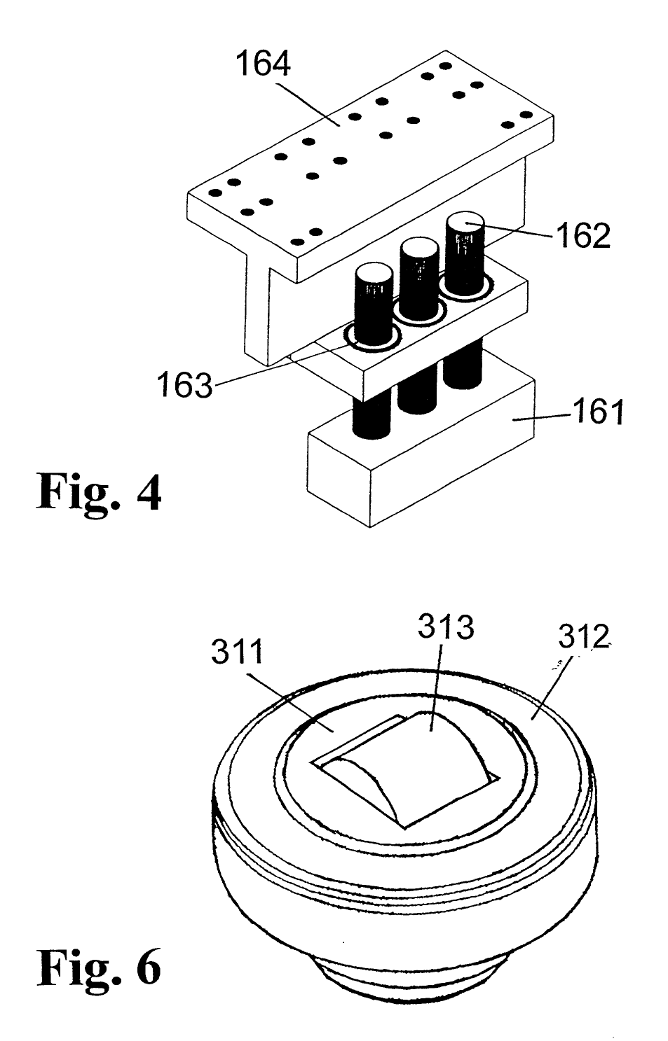

The upper sliding pendulum bearing 16 is shown in a magnified view in FIG. 4. A plurality of sliding pins 162 (preferably three) are rigidly fastened parallel to the mast direction in a connection plate 161 arranged orthogonally at the mast 1. Another connection element 164 with a plate oriented orthogonal to the sliding pins 162 is arranged at the supporting structure of the airplane (e.g., at the floor of an upper deck of the airplane), wherein self-aligning sliding bearing bushings 163 are recessed into the plate, their quantity and size being adapted to the sliding pins 162. The sliding bearing bushings 163 are embedded in elastic material (e.g., rubber), so that they are capable of compensating for a vertical displacement of the connection plate 161 relative to the connection element 164 supported by the airplane structure as well as a lateral deviation of the mast 1 (tilting by a few degrees).

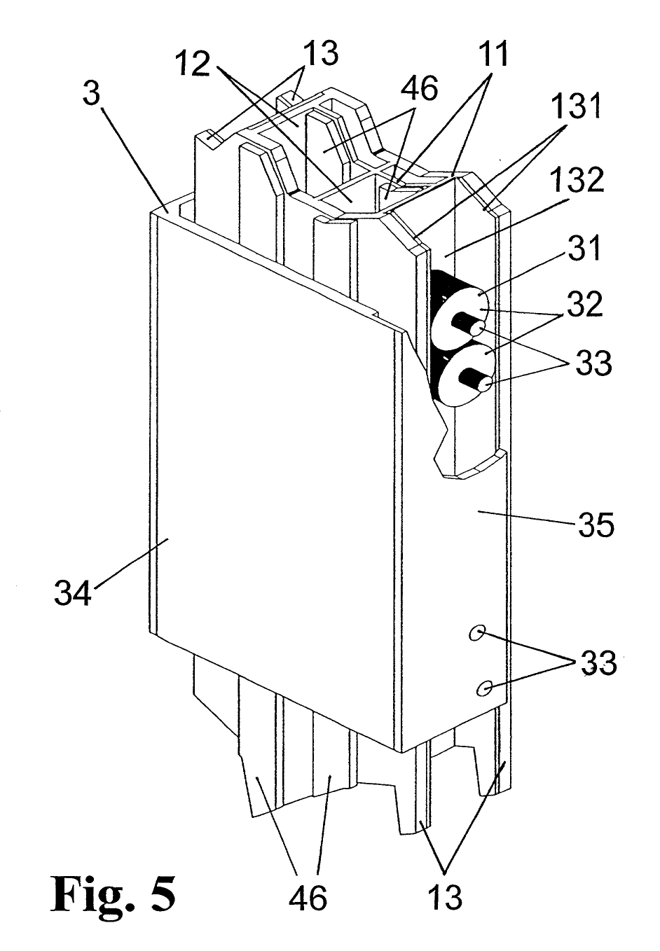

The play-free guidance of the carriage 3 at the mast 1 will now be shown in more detail with reference to FIG. 5. As was already mentioned in connection with FIG. 3, the guide rails 13 of the mast 1 are provided as a U-section for guiding the cabin carriage 3. Fitting therein, the carriage 3 has the shape of a wide U-section penetrated by the mast 1. Two pairs 32 of guide rollers 31 are arranged at the inner side of the sides or legs 35 of the carriage 3 in such a way that they engage in the opposing U-sections of the guide rails 13.

The guide rollers 31 for the upward movement and downward movement of the elevator cabin 2 are arranged at the carriage 3 in such a way that the two guide rollers 31 of a pair 32 roll respectively along different U-section legs 131 of the mast 1 as can be seen in the broken-away view of part of the carriage 3. The guide rollers 31 of a pair 32 are arranged closely adjacent to one another on shafts 33 so as to be offset relative to one another in the direction of the mast 1 (transporting direction). There are at least two such pairs 32 of guide rollers 31 in each U-shaped guide rail 13 for stable guidance of the carriage 3 at the mast 1 as will be seen in the lower part of the visible leg 35 of the carriage 3 from the indicated shafts 33.

In order to guide the carriage 3 also in the direction of the oppositely oriented guide rails 13 of the mast 1 without play, additional rollers are provided which roll on the U-section base 132. In this example, as will be seen from FIG. 6 for a guide roller 31, the guide rollers 31 themselves are constructed as two-roller systems for this purpose, wherein each guide roller 31 comprises a non-rotating central part 311 in which a small transverse guide roller 313 is embedded and an externally revolving main guide roller 312. The carriage 3 is accordingly guided and supported without play in its movement direction laterally (i.e., in both orthogonal directions of the horizontal plane). The large-area front side of the carriage 3 is the mounting surface 34 for the elevator cabin 2 at which the fastening of the elevator cabin 2 is carried out proceeding from the interior of the elevator cabin by means of a quick-closure, preferably via a pin (not shown) at the mounting surface 34 by means of a quarter-turn fastener or an eccentric lever.

While the foregoing description and drawings represent the present invention, it will be obvious to those skilled in the art that various changes may be made therein without departing from the true spirit and scope of the present invention.

Reference Numbers

1 mast

11 hollow section

12 channels

13 guide rail

131 U-section leg

132 U-section base

14 end module

15 lower mast fastening (pendulum bearing)

16 upper mast fastening (sliding pendulum bearing)

2 elevator cabin

3 carriage

31 guide rollers

311 central part

312 main guide roller

313 transverse guide roller

32 pairs (groups)

33 shafts

34 mounting surface

35 leg

4 drive system

41 drive motor

42 step-down gear unit

43 drive shaft

44 lower deflection rolls

45 upper deflection rolls

46 belt

461 spiral toothing

462 base material

463 strand inlay

464 wear-resistant layer

47 weight measuring device

What is claimed is:

1. An elevator system for the vertical transport of payloads in an aircraft, comprising:
an elevator cabin;
a mast for load carrying and for guiding the elevator cabin between different horizontal levels;
a drive system arranged at the mast, for moving and stopping the elevator cabin in a defined manner;
said drive system having at least one closed belt for driving and for receiving the load of the elevator cabin;
said belt being guided at the lower end and upper end of the mast on deflection rolls and having between the deflection rolls, at least one freely accessible belt portion oriented parallel to the mast for fastening said elevator cabin and for the movement of the elevator cabin along the mast;
said deflection rolls and said belt being provided with teeth which are adapted to one another and said belt being pretensioned in a defined manner; and
one of the deflection rolls communicating with a drive motor having a large torque and able to be well regulated;
said drive motor, apart from its driving function, being also provided for braking and holding the elevator cabin load.

2. The elevator system according to claim 1, wherein the toothing of the deflection rolls and belt has a lateral guide in addition.

3. The elevator system according to claim 2, wherein the deflection rolls and belt have a spiral toothing.

4. The elevator system according to claim 1, wherein the belt is formed of a base material of ductile plastic and longitudinally oriented strand inlays.

5. The elevator system according to claim 4, wherein the base material of the belt comprises polyurethane.

6. The elevator system according to claim 4, wherein steel wires are inserted in the base material of the belt.

7. The elevator system according to claim 4, wherein carbon fibers are inserted in the base material of the belt.

8. The elevator system according to claim 5, wherein the toothing of the belt has a more wear-resistant layer at the tooth flanks.

9. The elevator system according to claim 8, wherein said wear-resistant layer is polyamide.

10. The elevator system according to claim 1, wherein a plurality of belts are provided as load carrying means for the elevator cabin in order to increase reliability and security, wherein the deflection rolls of the belts which are guided next to one another are arranged on a common shaft at the upper end and lower end of the mast.

11. The elevator system according to claim 1, wherein the deflection rolls are mounted at the upper end of the mast on a shaft with a weight measuring device for monitoring belt tension and load limits of the elevator system, wherein an overload triggers the locking of the drive shaft and the switching off of the drive motor during load transport and the belt pretensioning can be checked and adjusted during idling.

12. The elevator system according to claim 1, wherein a tensioning device is provided for the belts, wherein the tensioning device is arranged in an area of the freely accessible belt portion that is concealed by the elevator cabin, so that the belt can be readjusted by applying defined pretensioning for extensive suppression of vertical vibrations.

13. The elevator system according to claim 1, wherein the drive motor has a measuring device for detecting rotor positions, wherein the position of the elevator cabin can be correlated to the rotor position of the drive motor by this measuring device via the toothing of the belts.

14. The elevator system according to claim 13, wherein the position of the elevator cabin relative to the floor of a respective deck of the aircraft is adjustable in a continuous manner by programming a controlling and regulating circuit which is arranged downstream of the measuring device for rotor position detection.

15. The elevator system according to claim 13, wherein the drive motor is guided at an AC converter which, based on the measurements of the rotor position, regulates the current of the drive motor, determines the exact position of the elevator cabin and moves specifically toward a predetermined position.

16. The elevator system according to claim 1, wherein the drive motor is a brushless DC servo motor.

17. The elevator system according to claim 1, wherein the drive motor is temperature-monitored.

18. The elevator system according to claim 1, wherein a suitable step-down gear unit is provided for generating or holding a torque required for driving and braking the drive shaft.

19. The elevator system according to claim 1, wherein a mechanical brake device is provided at the drive shaft for stopping the elevator cabin in the currentless state of the drive motor in case of overload or breakdown.

20. The elevator system according to claim 1, wherein the mast is formed of hollow sections whose quantity and size are adapted to the quantity and dimensions of the belts, wherein the hollow sections form channels for the return of the belts.

21. The elevator system according to claim 20, wherein the mast has end modules at the end of the hollow sections for receiving the deflection rolls.

22. The elevator system according to claim 1, wherein the mast has a lower and an upper mast fastening such that all of the weight is deliberately received in the supporting structure of the aircraft via the lower mast fastening the upper mast fastening being provided only for receiving all horizontal forces in a supporting structure of the aircraft which is situated higher.

23. The elevator system according to claim 22, wherein the lower mast fastening in a lower deck of the aircraft is a pendulum bearing for load carrying, wherein it is ensured that the mast is movable in the longitudinal axis and transverse axis of the aircraft about this pendulum bearing.

24. The elevator system according to claim 22, wherein the mast is fastened to a higher deck of the aircraft via a sliding pendulum bearing which fixes the mast in the longitudinal axis and transverse axis of the aircraft but does not offer resistance in opposition to the movements of the deck relative to one another.

25. The elevator system according to claim 22, wherein stiffening or reinforcement is provided in the supporting structure of the aircraft only in the region of the lower pendulum bearing.

26. The elevator system according to claim 1, wherein the mast has, at the sides in transverse direction to the side on which the elevator cabin is arranged, a section rail as guide rail for the movement of the elevator cabin.

27. The elevator system according to claim 1, wherein the mast has, at the sides in transverse direction to the side on which the elevator cabin is arranged, two U-sections located opposite one another as guide rails for the movement of the elevator cabin.

28. The elevator system according to claim 26, wherein a plurality of groups of guide rollers are provided for guiding the elevator cabin along each side of the mast, wherein the guide rollers of a group roll on different surfaces of the respective guide rail of the mast closely adjacent to one another.

29. The elevator system according to claim 28, wherein the guide rollers of a group are arranged so as to be offset relative to one another in direction of the guide rail.

30. The elevator system according to claim 28, wherein the guide rollers are grouped in pairs, at least two pairs rolling on each guide rail.

31. The elevator system according to claim 28, wherein the different rolling surfaces of the guide rollers in a guide rail with U-section are the inner sides of the U-section legs.

32. The elevator system according to claim 31, wherein the guide rollers are constructed as two-roller systems, wherein they have a non-rotating central part about which the main guide roller revolves and at which a smaller transverse guide roller is embedded on the front side with respect to the main guide roller in such a way that the two-roller system rolls in a defined manner at a U-section leg and at the U-section base of the guide rail.

33. The elevator system according to claim 1, wherein a carriage is provided between the mast and elevator cabin for coupling the elevator cabin to the freely accessible belt portion and for linear guidance along the mast, wherein the guide rollers for guiding the elevator cabin which engage laterally in the mast are fastened to the carriage, and there is a mounting surface for the rigid fastening of the elevator cabin.

34. The elevator system according to claim 33, wherein the carriage has the shape of a wide U-section, wherein the mast is essentially embedded inside this U-shaped carriage and the shafts of the guide rollers are oriented parallel to the mounting surface of the carriage at the inner sides of the legs of the carriage.

35. The elevator system according to claim 33, wherein the cabin is fastened to the carriage by a quick-closure to facilitate maintenance and exchange.

36. The elevator system according to claim 35, wherein at least one peg is provided at the carriage for load suspension of the elevator cabin, which peg has a quarter-turn fastener for securing the elevator cabin without slippage.

37. The elevator system according to claim 35, wherein at least one peg is provided at the carriage for load suspension of the elevator cabin, which peg has an eccentric lever for securing the elevator cabin to the peg without slippage.
